(19) United States
(12) Patent Application Publication
(10) Pub. No.: US 2012/0036483 A1
(43) Pub. Date: Feb. 9, 2012

(54) DEVICE, METHOD FOR DISPLAYING A CHANGE FROM A FIRST PICTURE TO A SECOND PICTURE ON A DISPLAY, AND COMPUTER PROGRAM PRODUCT

(75) Inventors: Michael SOEGTROP, Poing (DE); Christian ERBEN, Muenchen (DE)

(73) Assignee: INFINEON TECHNOLOGIES AG, Neubiberg (DE)

(21) Appl. No.: 12/852,535

(22) Filed: Aug. 9, 2010

(51) Int. Cl. G06T 13/00; G06F 15/16; G06F 3/048

(52) U.S. Cl. 715/839; 345/473; 709/201; 715/764

(57) ABSTRACT

A device is described having a memory storing data specifying a change animation between pictures to be displayed successively on the display, a setting circuit configured to store a setting specifying that a change animation between pictures to be displayed successively on the display is to be carried out in accordance with the specification of the change animation given by the data, a display controller configured to control a display to display a first picture, a detector configured to detect an event which triggers that a second picture is to be displayed on the display, a determination circuit configured to read the setting and to determine, based on the setting, a change animation between the first picture and the second picture, wherein the display controller is configured to control the display to display the change animation, and, after the change animation, to display the second picture.

### TECHNICAL FIELD

Embodiments generally relate to a device, a method for displaying a change from a first picture to a second picture on a display, and a computer program product.

### BACKGROUND

In computer programs, cross-fade effect may be used when the program surface changes from one picture to another picture, for example in accordance with a selection by the user. For example, in case of a program running on a mobile telephone, a cross-fade effect may be used when the user does a selection on the program interface, for example selects his address book, and the program surface is changing accordingly. Such a cross-fade effect of the program surface, i.e. of the graphical user interface of a program, is typically implemented using program libraries such as OpenVG or OpenGL in a programming language such as C. Thus, the cross-fade effects are a fixed part of the program, e.g. the operating system of a mobile telephone, and are therefore fixed for the specific version of the program. For example, the set of cross-fade effects used is fixed and may not be extended. Since it is very popular to customize or individualize mobile telephones, for example regarding the ringing tone used by the mobile telephone etc., it is also desirable to provide mobile telephone users with the option of customizing the cross-fade effects used by programs running on mobile telephones, e.g. used by the graphical operating system of the mobile telephone.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments are described with reference to the following drawings, in which:

FIG. 1 shows a device according to an embodiment.

FIG. 2 shows a flow diagram according to an embodiment.

FIG. 3 shows a mobile telephone according to an embodiment.

FIG. 4 shows a communication system according to an embodiment.

FIG. 5 illustrates a cross-fade effect.

FIG. 6 illustrates a cross-fade effect according to an embodiment.

FIG. 7 illustrates the storage format of the specification of the cross-fading effect illustrated in FIG. 6.

FIG. 8 illustrates a cross-fade specification file according to an embodiment.

### DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

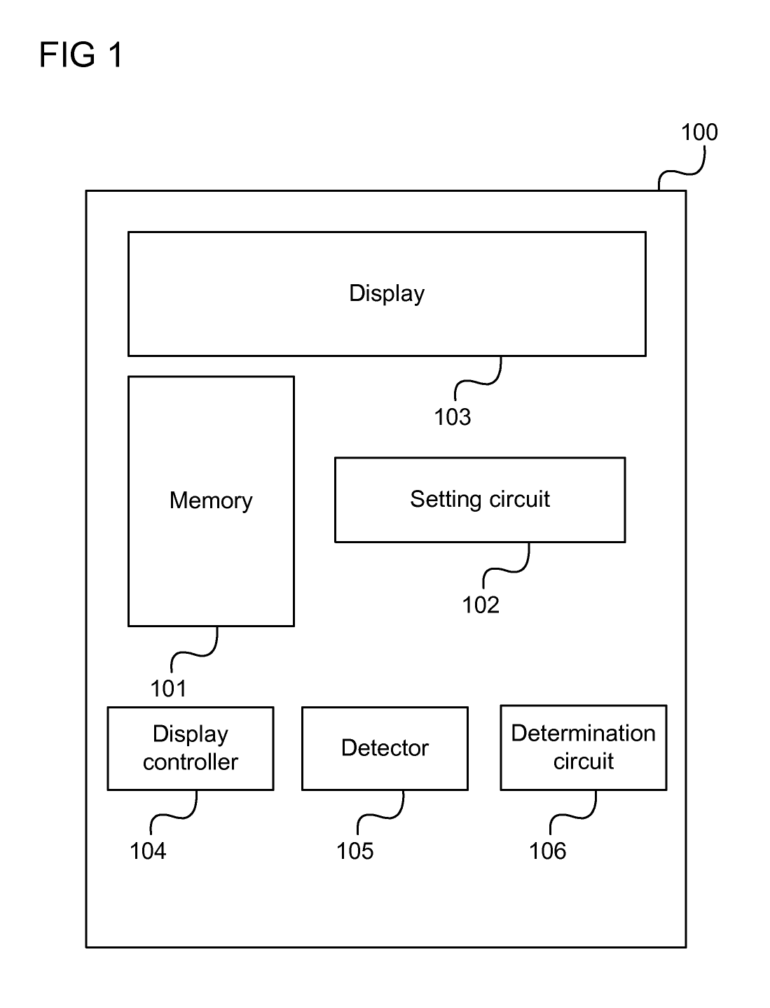

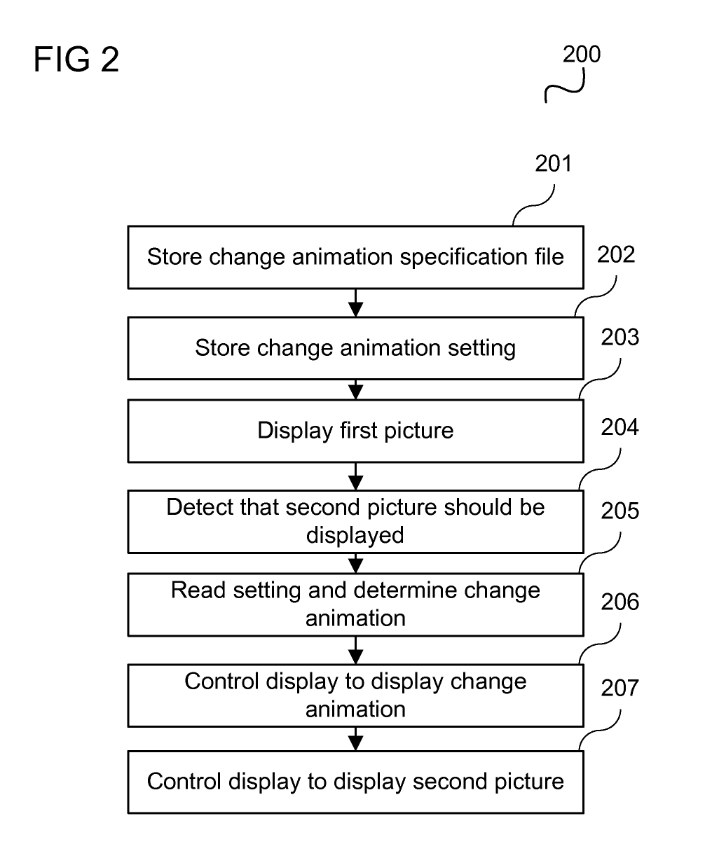

According to one embodiment, a device, for example a mobile telephone, allowing, for example, the device's user to customize cross-fade effects between pictures displayed, in other words change animations from one picture displayed to another picture displayed on the display. This is explained in more detail in the following with reference to FIGS. 1 and 2.

FIG. 1 shows a device 100 (e.g. an electronic device) according to an embodiment.

The device 100 includes a memory 101 storing data (e.g. in the form of a file or a data structure) specifying a change animation between pictures to be displayed successively on a display 103 of the device 100 and a setting circuit 102 configured to store a setting specifying that a change animation between pictures to be displayed successively on the display is to be carried out in accordance with the specification of the change animation given by the data (e.g. given in the file or in the data structure). The memory 101 may for example be a memory allowing read and write access (such as a RAM: random access memory) or may be a read-only memory (ROM) storing the file or the data structure. The data may also be stored in the form of a data unit, e.g. a resource, such as a part of a file.

The device 100 further includes a display controller 104 configured to control the display to display a first picture.

Additionally, the device 100 includes a detector 104 configured to detect an event which triggers that a second picture is to be displayed on the display and a determination circuit 105 configured to read the setting and to determine, based on the setting, a change animation between the first picture and the second picture.

The display controller 104 is configured to control the display to display the change animation, and, after the change animation, to display the second picture.

In other words, in one embodiment, when it is detected that a second picture is to be displayed following a first picture, it is determined from a setting how the change from the first picture to the second picture is to be displayed. The setting may for example specify data (e.g. a data set, a data unit, a file, or a data structure) that is to be read out which contain a specification of the change animation. The setting circuit may also read the specification of the data and store, as the setting, partially or completely the specification of the change animation. In one embodiment, the data may be downloaded from a server (e.g. in the form of a file) such that a specification of any change animation may be downloaded and installed in the device to be used for a change between pictures displayed.

According to one embodiment, the data are specifying the change animation in a structure description language. In other words, the change animation is specified by the data (e.g. in a file) in a format that specifies a structure in contrast to, for example, a programming language that also includes programming instructions.

In one embodiment, the data are specifying the change animation independent from the content of the first picture and the content of the second picture. For example, the content of the first picture and the content of the second picture are taken from one or more (other) files or are generated based on data from one or more (other) files. The data specifying the change animation (e.g. the data contained in a file) may thus be seen to include a generic specification of the change animation that is independent from the content of the pictures to which it is applied.

In one embodiment, the device is a communication device, for example a mobile communication device such as a mobile telephone.

The event is for example a selection input by the user of the device.

In one embodiment, the first picture shows at least one graphical icons to be selected by the user, the event is the selection of one of the graphical icons by the user and the second picture corresponds to the functionality symbolized by the graphical icon selected by the user.

The device may further include a receiver configured to receive the data (e.g. a file containing the data) via a communication network.

The device is for example a mobile communication device and is for example configured to receive the data from a base station of the communication network.

The device may be configured to receive the data from a server computer via the base station and may further include a sender configured to send a request for the data (e.g. a request for a specific file) via the communication network to the server computer.

The data (e.g. a file containing the data) are for example free of program instructions and/or is for example free of procedure calls and/or is for example free of script commands. This may increase the security of the usage of changeable or customizable change animations as provided by embodiments of the invention since the file may be in a format that does allow specifying change animations but that does not allow including instructions that could compromise security such as would be the case, e.g., when using a Java Applet or similar program code. Furthermore, it should be noted that a Java Applet does typically not allow sufficient execution speed for implementing a graphical animation.

The change animation may for example be seen to be described according to a media description. The specification of the change animation may be platform independent.

The data may allow an easy customization of a change animation carried out by the device since only the data (e.g. only a (single) file) has to be exchanged when a user wants to have a different change animation. In one embodiment, there is no need for changing the programming of the device, for example.

In one embodiment, the data (e.g. the file or data structure containing the data) are free of picture content, e.g. free of textural content shown in the first picture and/or shown in the second picture.

In one embodiment, the data specify a mapping of the first picture to a plurality of polygons, the change animation includes at least one frame displayed on the display after the first picture and before the second picture and the data specify the position of the vertices of the polygons on the display for the at least one frame. In other words, the data may specify the picture coordinates (i.e. the screen coordinates of the display) of the vertices and may specify, for each polygon, the content of the first picture in texture coordinates that is to be mapped to the polygon. In this embodiment, the display controller may be configured to display the frame after the first picture and before the second picture according to the data.

In one embodiment, the memory is storing a plurality of data units (e.g. a plurality of files or a plurality of data structures) each specifying a change animation between pictures to be displayed successively on the display and the setting circuit is configured to select one of the data units and to store a setting specifying that a change animation between pictures to be displayed successively on the display is to be carried out in accordance with the specification of the change animation given in the selected data unit. In other words, in one embodiment, there may be a selection (e.g. according to a user input) from a plurality of change animations to be used for a change from a first picture to a second picture.

The device 100, for example a mobile communication device, e.g. a mobile telephone, for example carries out the method illustrated in FIG. 2.

FIG. 2 shows a flow diagram 200 according to an embodiment.

The flow diagram 200 illustrates a method for displaying a change from a first picture to a second picture on a display.

In 201, data (e.g. in the form of a file or a data structure) is stored specifying a change animation between pictures to be displayed successively on the display.

In 202, a setting is stored specifying that a change animation between pictures to be displayed successively on the display is to be carried out in accordance with the specification of the change animation given by the data (e.g. in a file or by a data structure).

In 203, the display is controlled to display the first picture.

In 204 an event is detected which triggers that the second picture is to be displayed on the display.

In 205, the setting is read and it is determined, based on the setting, a change animation between the first picture and the second picture.

For determining the change animation, the change animation information from the data may be decoded and combined with the texture information, i.e. with the content of the first picture and the second picture. For example, the content of the first picture may be combined with the change animation information (e.g. by a mapping of the content of the first picture to polygons) after 203 in preparation of the change animation. Similarly, the content of the second picture may be combined with the change animation information (e.g. by a mapping of the content of the second picture to polygons) in preparation of the change animation or, depending on the type of change animation, shortly before the display of the second picture (e.g. between 206 and 207 below).

In 206, the display is controlled to display the change animation.

In 207, the display is controlled to display the second picture.

In one embodiment, a computer program product is provided including instructions which, when executed by a processor, make the processor perform the method described above with reference to FIG. 2.

It should be noted that embodiments and examples described in the context with the device are analogously valid for the method and the computer program product.

In the following, an embodiment is explained in more detail.

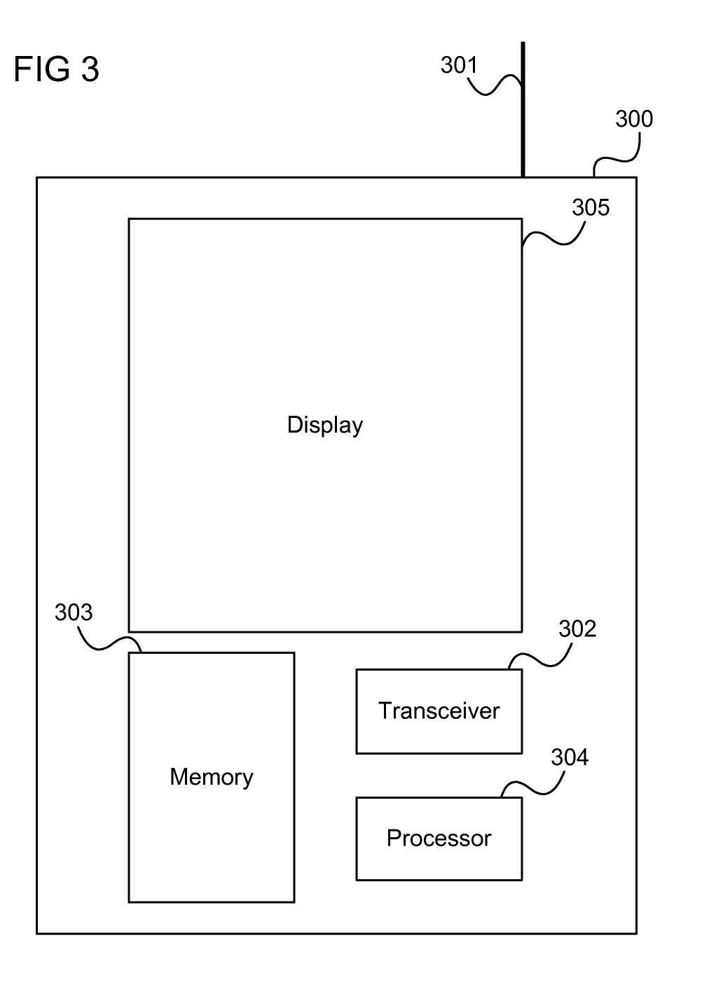

FIG. 3 shows a mobile telephone 300 according to an embodiment.

The mobile telephone 300 includes an antenna 301 and a transceiver 302 allowing communication, for example with other mobile telephones, via a cellular mobile communication network such as a GSM (Global System for Mobile Communication) communication network or a UMTS (Universal Mobile Telecommunication System) communication network.

The mobile telephone 300 further includes a memory 303 which may be used to store program code or data used for example by programs running on the mobile telephone 300 and a processor 304 allowing to run programs on the mobile telephone 300.

Further, the mobile telephone 300 includes a display 305 that may be used by programs running on the mobile telephone 300 for displaying a graphical program surface such as a graphical user interface, for example a basic interface allowing the user to select from various functionalities of the mobile telephone 300, e.g. allowing the user to browse his address book, to compose an SMS (Short Message Service) message etc.

A program running on the mobile telephone 300 by means of the processor 304 may have a plurality of different program surfaces and the program surface that is displayed by the program by means of the display 305 typically depends on the input by the user. For example, a first program surface may show a couple of icons which the user may select for selecting a certain functionality and if the user selects one of the icons, for example an address book icon, the displayed program surface changes to a screen or picture showing the names of the contacts of the user. In other words, a program running on the mobile telephone 300 and using the display 305 for displaying program surfaces, for example graphical user interfaces or graphical user interface screens, may first display a first picture (i.e. a first graphical program surface) and may then switch to the display of a second picture (i.e. a second graphical program surface).

The program may for example be a program for showing a slide show wherein the program surface changes from one screen to another screen. Such a program may also, alternatively to a mobile telephone, run on a laptop or desktop computer.

The switch (or change) from the first picture to the second picture on the display 305 may be carried out according to a change animation, also referred to in the following as a cross-fade effect. For example, the first picture may become more and more transparent and the second picture is shown behind the first picture such that the second picture more and more replaces the first picture or the first picture may be moved to one side of the screen and disappears to the side of the screen such that the second picture seems to remain on the screen while the first picture is removed etc. It should be noted that cross fade effect is not necessarily meant to mean that the first picture actually fades, i.e. is getting more and more transparent, but is meant to include any kind of change animation including the first picture getting more transparent, being moved to one of the sides (and eventually being moved of the display area) getting smaller and smaller until it is no longer visible, the picture content of the first picture morphing into the picture content of the second picture etc.

In one embodiment, the mobile telephone 300 is configured to receive a file which contains a specification of a cross-fade effect. The mobile telephone 300 may for example store this file in the memory 303 and the program running on the mobile telephone 300 which supports using cross-fade effects when switching from the display of one picture to another picture may carry out a cross-fade effect for switching from a first picture to a second picture in accordance with the specification given in the file stored in the memory 303. It should be noted that in other embodiments, the specification of a cross-fade effect may be pre-stored in the memory 303. For example, the memory 303 may be a read-only memory storing the specification. The data described in the following to be contained in the file may, in other embodiments, be stored in the form of a data structure or a data unit which is not necessarily embedded in a file system and may for example correspond to a part of a file or any other resource.

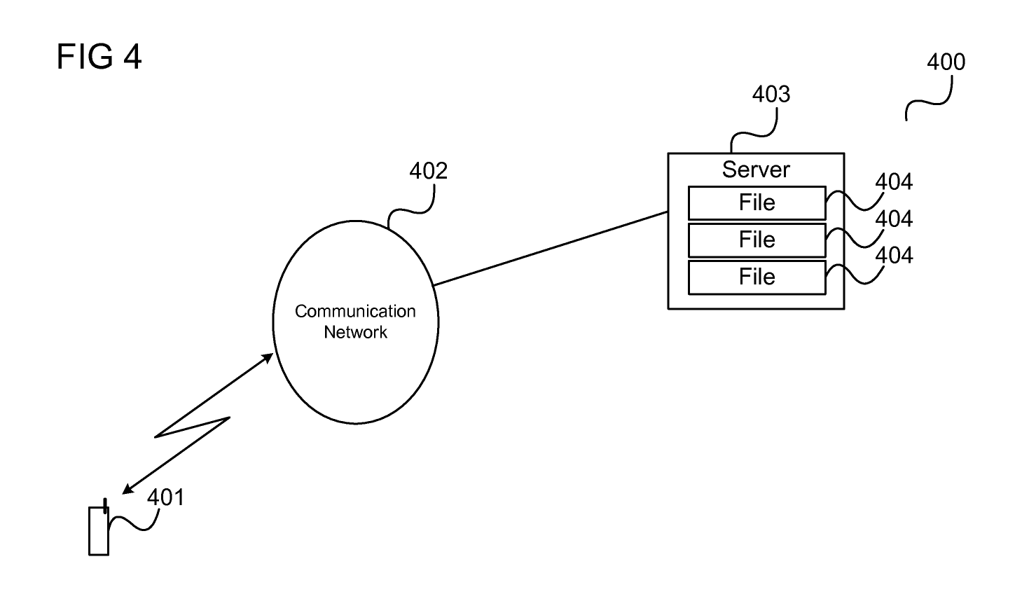

The file containing the specification of the cross-fade effect (or in one embodiment of a plurality of cross-fade effects from which the program, for example in accordance with the user input, may select) may be downloaded by the mobile telephone 300 from the server of a provider of cross-fade effects or cross-fade effects specifications. This is illustrated in FIG. 4.

FIG. 4 shows a communication system 400 according to an embodiment.

A communication system 400 includes a mobile telephone 401, which for example corresponds to the mobile telephone 300 shown in FIG. 3, a communication network 402, for example a cellular mobile communication network such a GSM communication network or a UMTS communication network, and a server computer 403.

In this example, the server computer 403 stores a plurality of files 404 where each file 404 contains the specification of one (or, in one embodiment one or more) cross-fade effects.

By accessing the server 403 via the communication network 402, the mobile telephone 401 may download one or more of the files 404, store it or them in its memory 303 and carry out a cross-fade effect according to the specification of a cross-fade effect in one of the files 404.

The files 404 may for example be stored in the server 403 by a provider of cross-fade effects and the cross fade effects are for example provided by a designer team and the user of the mobile telephone 300 may be charged with a fee when downloading a file 404, for example may be charged with a fixed fee for downloading of the files 404.

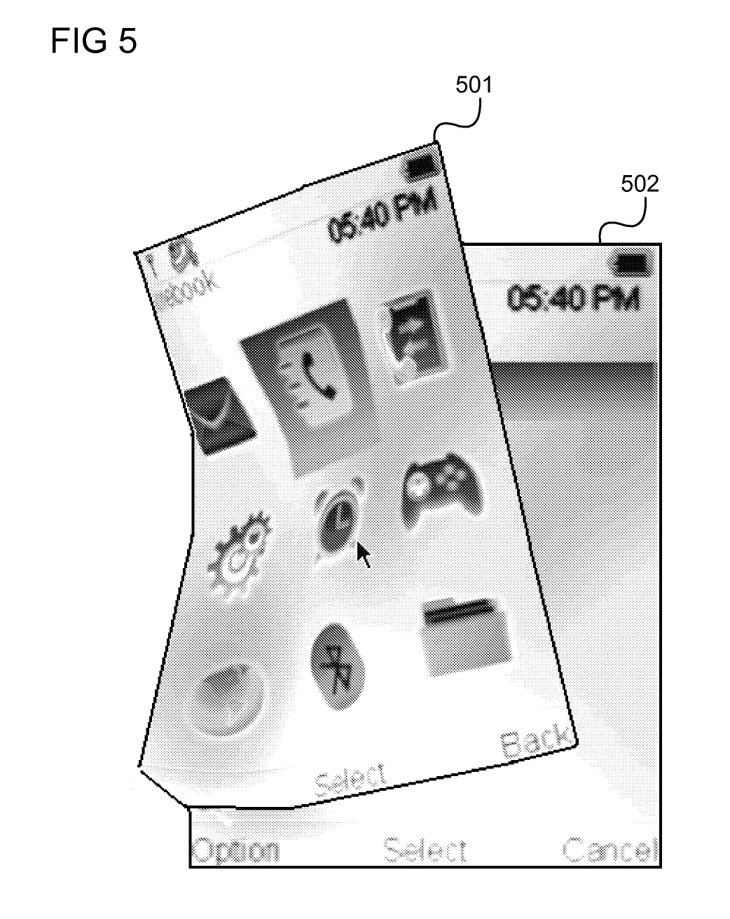

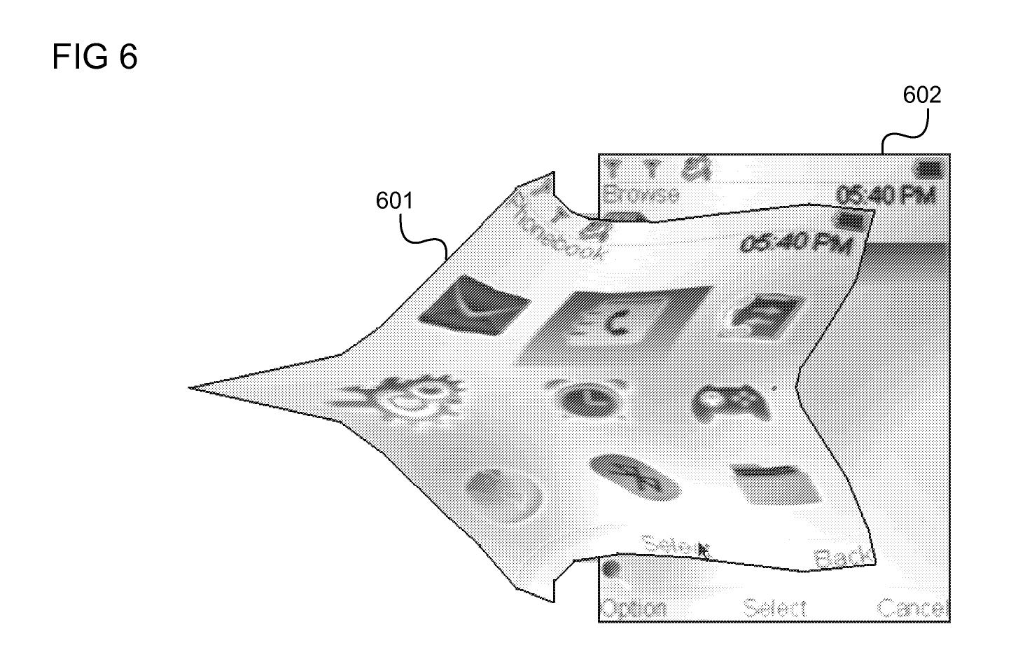

In the following, examples for cross-fade effects are described with reference to FIGS. 5 and 6.

FIG. 5 illustrates a cross-fade effect.

The illustration in FIG. 5 shows the state of the display 305 when the cross-fade between a first picture and a second picture is currently taking place, for example, shows the state of the display 305 in the middle of the cross-fading between the first picture and the second picture. In this stage, the display 305 shows a first picture element 501 and the second picture element 502. The first picture element 501 corresponds to the first picture and the second picture element 502 corresponds to the second picture 502. In this example, the cross-fade effect was designed to give the impression like if the first picture was painted on a first sheet which lies above a second sheet on which the second picture is painted and like if the first sheet was blown away from below such that at the end of the cross-fading the second picture remains.

Accordingly, the first picture element 501 shows the content of the first picture in distorted form giving the impression like if the first picture was bent by a wind blowing from below the first picture. The second picture element 502 shows the content of the second picture in undistorted form but being partially hidden by the first picture element 501 like if the first picture was on top of the second picture before the switching began. As can be seen from the first picture element 501, the first picture corresponds to a selection screen of a program running on the mobile telephone 300 allowing the user to select between various functionalities of the mobile telephone 300, for example an Internet browser program, games, a music player, a calendar, etc. The second picture, as can be seen from the second picture element 502, corresponds in this example to a screen allowing the user to browse his contacts.

Another cross-fade effect according to one embodiment which is applied to the same two pictures as the cross fade effect illustrated in FIG. 5 is illustrated in FIG. 6.

FIG. 6 illustrates a cross-fade effect according to an embodiment.

Similarly to FIG. 5, a first picture element 601 corresponds to the first picture, and the second picture element 602 corresponds to the second picture. Again, the cross-fade effect is designed to give the impression to the user that a sheet on which the first picture is painted is, at the start of the cross-fade effect, lying on top a second sheet showing the second picture and is being removed when the display 305 switches from the first picture to the second picture. In this example, in contrast to the example described above with reference to FIG. 5, the cross-fade effect should not give the impression of the first picture being blown away from the top of the second picture but the first picture being grabbed from the side and ripped off (or drawn away from) the top of the second picture. Accordingly, the first element 601 shows a distorted version of the content of the first picture and the second picture element 602 shows the content of the second picture in undistorted form but is partially hidden by the first picture element 601.

It should be noted that only the parts of FIGS. 5 and 6 are shown that correspond to the area defined by the respective second picture element 502, 602. The parts of the first picture elements 501, 601 that are “off-screen” and are thus not shown on the display are merely shown in FIGS. 5 and 6 for illustration.

It should be noted that analogously to the content of the first picture, the content of the second picture may be shown, e.g. in distorted form, in frames of the cross-fade effect. For example, the cross-fade effect may give the impression that the content of the second picture moves into the display area at may for example be shown in distorted form at first and, in course of the cross-fade effect, change to its form as given by the second picture. Such an effect using the content of the second picture may be implemented analogously as the effects using the content of the first picture as described herein.

As mentioned above, a specification of a cross-fade effect, such as a specification of the cross-fade effect illustrated in FIG. 5 or a specification of the cross-fade effect illustrated in FIG. 6, may be included in a file. In other words, a cross-fade effect may be included, similar to a video clip, in a file and the specification of the cross-fade effect may be read out by a program, for example the graphical operating system, of the mobile telephone 300 and may be played, i.e. the program may show the switch from a first picture to a second picture in accordance with the cross-fade effect. A difference between the specification of a cross-fade effect in a file and the specification of a video in a video file may be seen in that the video file describes the complete display content, e.g. describes a plurality of frames according to the video including the picture content of the frames, while the specification of a cross-fade effect in a file according to an embodiment only specifies the graphical change (which may also correspond to a plurality of frames showing the various stages of the cross-fade effect) from a first given picture to a second given picture without specifying the content of the pictures itself.

In other words, the cross-fade effect specification file only specifies how given picture content has to be transformed but does not include information about the picture content itself.

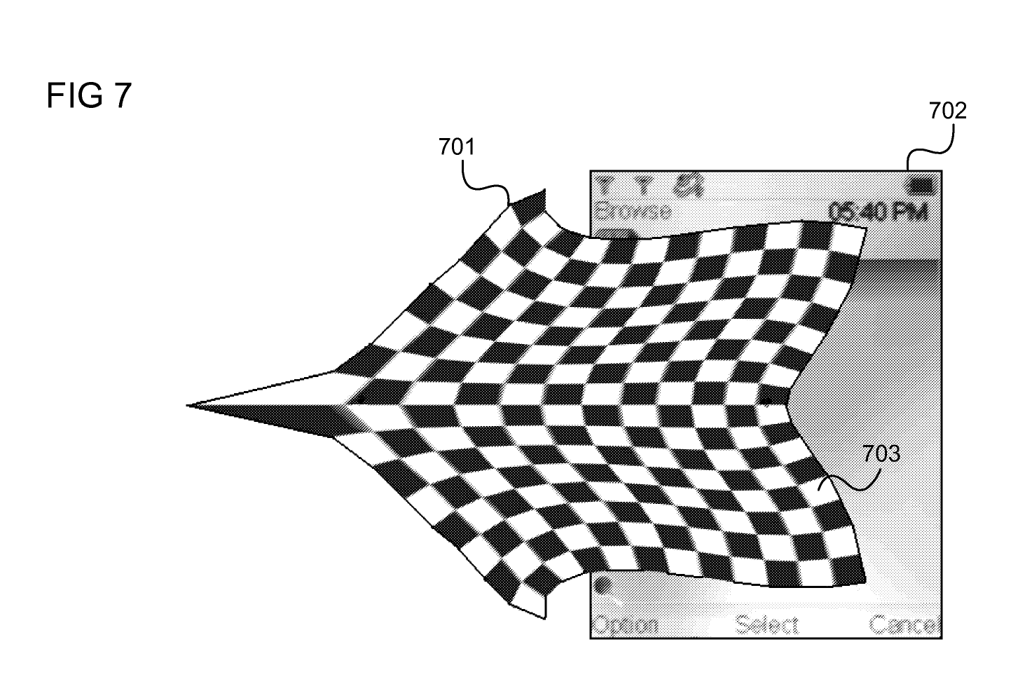

The cross-fade effect may be stored in a file similar to a video clip as a sequence of frames wherein each frame includes a set of polygons with texture coordinates according to which picture content of the first picture or the second picture, respectively, is mapped to the polygons. This means that the texture used for the polygons corresponds to the picture contents which are cross-faded. This is explained in more detail with reference to FIG. 7.

FIG. 7 illustrates the storage format of the specification of the cross-fading effect illustrated in FIG. 6.

In FIG. 7, the first picture element 601 of FIG. 6 is replaced by a pattern or grid 701 looking like a chessboard which illustrates the usage of polygons, in this example quadrangles 703, for definition of the cross-fade effect. The picture element 702 shown in FIG. 7 corresponds to the second picture element 602 as described with reference to FIG. 6.

As explained above, the state of the display as shown in FIG. 7 (and as shown in FIG. 6 in which the first picture element 601 is shown with the actual picture content of the first picture) corresponds to an intermediate state of the cross-fade effect. In other words, the state of the display corresponding to the illustrations in FIG. 6 and FIG. 7 corresponds to one frame of the cross-fade effect. For this frame (and for all other frames displayed during the cross-fade effect) the cross-fade specification file, i.e. the file containing the specification of the cross-fade effect, contains the coordinates (e.g. the corner coordinates) of the quadrangles 703 in picture coordinates, i.e. in coordinates of the display space corresponding to the display 305 or, in other words, in coordinates of the screen.

Furthermore, the cross-fade specification file specifies, for each frame of the cross-fade effect and for each quadrangle 703, the picture coordinates, for example of the first picture, which corresponds to this quadrangle 703, or, in other words which is mapped to this quadrangle 703 and which is shown in the display area defined by this quadrangle 703.

For example, for each quadrangle 703, a quadrangular area of the first picture may be specified, such that the quadrangle 703, when undistorted, i.e. when for example in the form of a square, corresponds to the quadrangular area of the picture content that is specified for it, i.e., that is mapped to it. In other words, the first picture may be seen to be subdivided into the quadrangles 703.

When in a frame of the cross-fade effect, such as in the frame illustrated in FIGS. 6 and 7, the quadrangles 703 are distorted, the picture content mapped to a quadrangle 703 are distorted analogously to the distortion of the quadrangle 703 with respect to its undistorted rectangle or square shape as can be seen in the illustrations of FIG. 6 and FIG. 7.

A frame of the cross-over effect may be defined using a plurality of meshes for example for defining various pictures parts such as for defining a background and a foreground etc. For example, a cross-fade effect may be used in a program which shows a plurality of music album covers allowing to select a user a corresponding music album. For example, one music album cover is shown larger than the other music album covers and the cross-fade effect is displayed when a user changes the music album cover that is shown larger than the other music album covers. In this case, for example, each music album cover may be defined using its own mesh and the contents of the first picture may in this case be given by a plurality of subpictures, wherein each subpicture shows one of the music album covers and is mapped to its own mesh.

In other words, subpictures may be divided into a plurality of polygons (such as quadrangles as above) which are grouped to one mesh for each subpicture and in each frame of the cross-fade effect, the contents of each subpicture may be displayed in accordance with a possible distortion of the polygons of the respective mesh.

Furthermore, it should be noted that the polygons which are adjacent to each other in accordance with the mapping of the first picture to the group of polygons may be separated in frames shown during the cross-fade effect.

For example, one cross-fade effect may be that the first picture is looking like it was shattered by a ball flying into the screen and the parts of the first picture were falling apart according to the shattering. In this case, polygons may be separated from each other in the frames of the cross-fade effect such that there is the effect to the user that the contents of the first picture are being shattered and falling apart.

Furthermore, as in the above example of a ball shattering the first picture, additional textures which are not part of the first picture itself may be included in the intermediate frames of the cross-fade effect, such as a texture visualizing the ball shattering the first picture. In other words, the cross-effect specification may include extra picture content which is used in addition to the picture content of the first picture and/or the second picture.

Additional effects may also be included like polygons getting transparent, i.e. the picture content corresponding to a polygon getting more transparent from frame to frame to more and more show, for example, the second picture that is located beneath the first picture. Additionally, it is for example possible to generate reflection effects by mapping picture content of the first picture to a plurality of polygons and thus, for example, generating the effect that picture content mapped to one polygon is reflected by mapping the same picture content upside down to a polygon located for example beneath to generate the impression of a reflecting water or a metal surface.

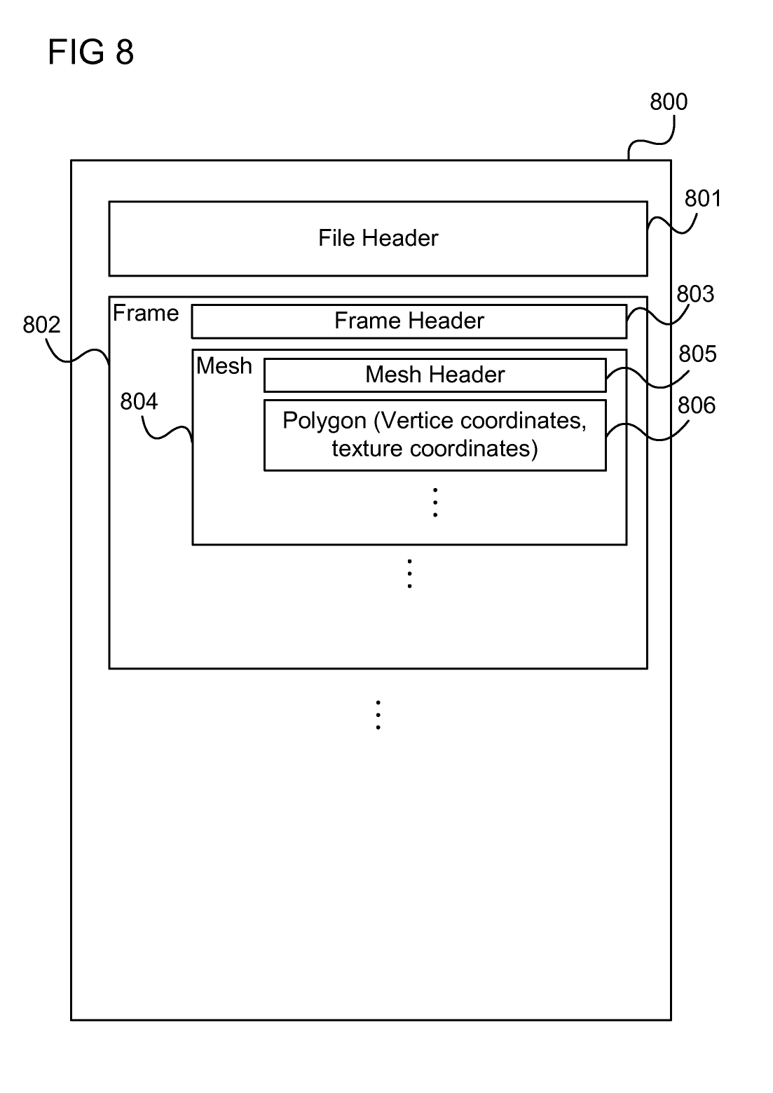

A possible format of a file 404 specifying a cross-fade effect is described in the following with reference to FIG. 8.

FIG. 8 illustrates a cross-fade specification file according to an embodiment.

In this example, the file 800 includes a header 801 which may include various information such as the number of frames or information used about a coordinate mapping or a coordinate scaling that is used in the file 800. Following the header 801 there is for each frame of the cross-fade effect a frame data structure 802 which may again include a header 803 which contains information about the frame, for example the number of meshes of the frame.

For each mesh of the frame, the frame data structure 802 includes a mesh data structure 804, which may again have a header 805 for example specifying the number of polygons of the mesh, the texture, i.e. the picture or the subpicture that is mapped to the polygons of the mesh, the transparency of the polygons of the mesh in the frame, etc.

Further, for each polygon (or for each face of the mesh), the mesh data structure 804 includes a polygon data structure 806 which specifies the location of the polygon in the current frame in picture coordinates, for example, and specifies the part of the texture, e.g. the picture content or subpicture content, that is mapped to the polygon, for example in coordinates of the texture.

In the following, a part of a possible cross fade specification file (or generally the form of the cross fade specification data) is shown in table 1 as an example.

TABLE 1
Example for first part of cross fade specification file

| | |
|---|---|
| 1 | BACKGROUND_COLOR R=205 G=205 B=205 |
| 2 | CAMERA |
| 3 | PERSPECTIVE FOCUS=40.0000 |
| 4 | POSITION X=0.000000 Y=0.000000 Z=10.000000 |
| 5 | FRONT=0.100000 |
| 6 | BACK=100.000000 |
| 7 | WIDTH=320 |
| 8 | HEIGHT=240 |
| 9 | CAMERA END |
| 10 | FRAMESET NFRAMES=16 |
| 11 | FRAME NMESHES=16 |
| 12 | MESH NFACES=1 |
| 13 | TWOSIDE=0 |
| 14 | VERTEXALPHA=0 |
| 15 | ALPHA=1.000 |
| 16 | SHADING=0 |
| 17 | ZTRANSP=0 |
| 18 | TEXTURE=INPUT_0008.png |
| 19 | FACE NVERTICES=4 |
| 20 | VERTEX X=4.912567 Y=2.700000 |
| | Z=0.072654 U=1.000000 |
| | V=1.000000 |
| 21 | VERTEX X=4.287433 Y=2.700001 |
| | Z=−3.472653 U=0.000000 |
| | V=1.000000 |
| 22 | VERTEX X=4.287433 Y=−0.900000 |
| | Z=−3.472654 U=0.000000 |
| | V=0.000000 |
| 23 | VERTEX X=4.912567 Y=−0.900000 |
| | Z=0.072654 U=1.000000 |
| | V=0.000000 |
| 24 | FACE END |
| 25 | MESH END |

Lines 1 to 10 can be seen to correspond to file header 801, line 11 can be seen to correspond to the frame header 803, lines 12 to 18 can be seen to correspond to the mesh header 805 and lines 20 to 23 can be seen to correspond to the polygon data structure 806, wherein, in this example, the polygon data structure includes in line 19 the specification of the number of vertices of the polygon and may thus be seen to include a polygon data structure header. Alternatively, the number of vertices of all polygons may be the same for a mesh, a frame, or all frames and may thus be also specified in the file header 801, the frame header 803, or the mesh header 805, respectively.

As explained above, the texture may be given by the first picture but may also be given by picture parts which may for example occur, for example already in distorted form (such as an album cover that is shown to be turned to the side), in the first picture.

As explained above, using the information of the cross-fade specification file 800, a program running on the mobile telephone 300 may generate a cross-fade effect starting from a first picture and ending at a second picture. It should be noted that the coordinates given in the cross-fade specification file 800 may be scaled by the program or the program may define some coordinates by itself to allow the program to adapt a cross-fade effect for example to the size of the entries of a list shown on the display 305. Furthermore, the file 800 may be a compressed.

The file 800 may be generated using suitable software such as an 3D animation program, for example the open source 3D animation program “Blender” for creating cross-fade effects. A cross-fade effect generated using such a software may then be stored in the format as explained with reference to FIG. 8 using a corresponding export filter provided according to one embodiment and may for example then be compressed using a suitable compressing program.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A device comprising:
a display;
a memory storing data specifying a change animation between pictures to be displayed successively on the display;
a setting circuit configured to store a setting specifying that a change animation between pictures to be displayed successively on the display is to be carried out in accordance with the specification of the change animation given by the data;
a display controller configured to control the display to display a first picture;
a detector configured to detect an event which triggers that a second picture is to be displayed on the display;
a determination circuit configured to read the setting and to determine, based on the setting, a change animation between the first picture and the second picture;
wherein the display controller is configured to control the display to display the change animation, and, after the change animation, to display the second picture.

2. The device according to claim 1, wherein the data are specifying the change animation in a structure description language.

3. The device according to claim 1, wherein the data are specifying the change animation independent from the content of the first picture and the content of the second picture.

4. The device according to claim 1, wherein the device is a communication device.

5. The device according to claim 4, wherein the device is a mobile communication device.

6. The device according to claim 5, wherein the device is a mobile telephone.

7. The device according to claim 1, wherein the event is a selection input by the user of the device.

8. The device according to claim 7, wherein the first picture shows at least one graphical icons to be selected by the user, the event is the selection of one of the graphical icons by the user and the second picture corresponds to the functionality symbolized by the graphical icon selected by the user.

9. The device according to claim 1, further comprising a receiver configured to receive the data via a communication network.

10. The device according to claim 9, wherein the device is a mobile communication device and is configured to receive the data from a base station of the communication network.

11. The device according to claim 10, wherein the device is configured to receive the data from a server computer via the base station.

12. The device according to claim 11, further comprising a sender configured to send a request for the data via the communication network to the server computer.

13. The device according to claim 1, wherein the data are free of program instructions.

14. The device according to claim 1, wherein the data are free of procedure calls.

15. The device according to claim 1, wherein the data are free of script commands.

16. The device according to claim 1, wherein the data are free of picture content.

17. The device according to claim 1, wherein the data specify a mapping of the first picture to a plurality of polygons, the change animation comprises at least one frame displayed on the display after the first picture and before the second picture and the data specify the position of the vertices of the polygons on the display for the at least one frame.

18. The device according to claim 17, wherein the display controller is configured to display the frame after the first picture and before the second picture according to the data.

19. The device according to claim 1, wherein the memory is storing a plurality of data units each specifying a change animation between pictures to be displayed successively on the display and the setting circuit is configured to select one of the data units and to store a setting specifying that a change animation between pictures to be displayed successively on the display is to be carried out in accordance with the specification of the change animation given in the selected data unit.

20. A method for displaying a change from a first picture to a second picture on a display comprising:
storing data specifying a change animation between pictures to be displayed successively on the display;
storing a setting specifying that a change animation between pictures to be displayed successively on the display is to be carried out in accordance with the specification of the change animation given by the data;
controlling the display to display the first picture;
detecting an event which triggers that the second picture is to be displayed on the display;
reading the setting and determining, based on the setting, a change animation between the first picture and the second picture;
controlling the display to display the change animation, and, after the change animation, to display the second picture.

21. A computer program product comprising instructions which, when executed by a processor, make the processor perform a method for displaying a change from a first picture to a second picture on a display, the method comprising:
storing data specifying a change animation between pictures to be displayed successively on the display;
storing a setting specifying that a change animation between pictures to be displayed successively on the display is to be carried out in accordance with the specification of the change animation given by the data;
controlling the display to display the first picture;
detecting an event which triggers that the second picture is to be displayed on the display;
reading the setting and determining, based on the setting, a change animation between the first picture and the second picture;
controlling the display to display the change animation, and, after the change animation, to display the second picture.
